(19) United States
(12) Patent Application Publication
(10) Pub. No.: US 2016/0236081 A1
(43) Pub. Date: Aug. 18, 2016

(54) SYSTEMS AND METHODS FOR INTEGRATING REAL-WORLD AND IN-GAME COMMUNICATIONS OF A USER

(71) Applicant: Mail.ru Games LLC, Moscow (RU)

(72) Inventor: GEVORG GLECHYAN, Moscow (RU)

(21) Appl. No.: 14/625,590

(22) Filed: Feb. 18, 2015

(51) Int. Cl. A63F 13/31

(52) U.S. Cl. CPC A63F 13/31

(57) ABSTRACT

A computerized system for enabling a game-related communication with a user participating in a game, the system incorporating: a game server configured to communicate with a game client, the game client being directly accessed by the user participating in the game, the game server further configured, together with the game client, to enable the game involving the user, the game server comprising a real-life communication frontend, the real-life communication frontend configured to communicate with a real-life communication client directly accessible by the user, the real-life communication client being separate and distinct from the game client, the real-life communication frontend being further configured to send a game-related notification to the real-life communication client of the user.

### BACKGROUND OF THE INVENTION

1. Field of the Invention

The disclosed embodiments relate in general to the field of computer gaming technology and in particular to computer-implemented systems and methods for integrating real-world and in-game communications of a user.

2. Description of the Related Art

In-game communication functionality became an important part of modern gaming technology. Game players utilize the in-game communications to discuss the game and game-related topics with their friends and other game players. The availability of a communication with other game players greatly increases users' involvement in the game.

In-game communications is conventionally implemented using the gaming client software installed on client gaming devices as well as the gaming server. Therefore, the conventional gaming communication functionality may be used only through the gaming software, during active game session and by users involved in the game. Thus, using conventional technology it is impossible to communicate by way of in-game communications using other communication software applications or with users not involved in the active game session.

Therefore, new and improved systems and methods for integrating communication devices of real-life users with virtual in-game communication means are needed that would enable real-life users to engage in the in-game communication using their standard real-life communication devices.

### SUMMARY OF THE INVENTION

The inventive methodology is directed to methods and systems that substantially obviate one or more of the above and other problems associated with conventional techniques for implementing in-game communications.

In accordance with one aspect of the embodiments described herein, there is provided a computerized system for enabling a game-related communication with a user participating in a game, the system incorporating: a game server configured to communicate with a game client, the game client being directly accessed by the user participating in the game, the game server further configured, together with the game client, to enable the game involving the user, the game server comprising a real-life communication frontend, the real-life communication frontend configured to communicate with a real-life communication client directly accessible by the user, the real-life communication client being separate and distinct from the game client, the real-life communication frontend being further configured to transmit a game-related notification to the real-life communication client of the user.

In one or more embodiments, the real-life communication frontend is a voice-over-IP frontend and wherein the real-life communication client is a phone of the user.

In one or more embodiments, the real-life communication frontend is an SMS frontend and wherein the real-life communication client is a phone of the user.

In one or more embodiments, the real-life communication frontend is an email frontend.

In one or more embodiments, the real-life communication frontend is an instant messaging frontend and wherein the real-life communication client is an instant messaging client of the user.

In one or more embodiments, the game-related notification comprises a pre-recorded video message.

In one or more embodiments, the game-related notification comprises a pre-recorded audio message.

In one or more embodiments, the game server further comprises an in-game communication frontend, wherein the game client comprises an in-game communication client portion and wherein the in-game communication frontend of the game server is configured to communicate with the in-game communication client portion of the game client using a game communication protocol.

In one or more embodiments, the game server is further configured to receive a response to the game-related notification from the user, to process the received response and to take a game-related action based on the received response.

In one or more embodiments, the game-related notification comprises an instruction for the user regarding providing the response to the game-related notification.

In accordance with another aspect of the embodiments described herein, there is provided a computer-implemented method for enabling a game-related communication with a user participating in a game, the computer-implemented method being performed in connection with a computerized system incorporating: a game server comprising a real-life communication frontend, a game client being directly accessed by the user participating in the game and a real-life communication client being directly accessed by the user, the computer-implemented method involving: establishing a communication between the game server and the game client; using the game server and the game client to enable the game involving the user; and establishing a game-related communication between the real-life communication frontend of the game server and the real-life communication client of the user; and transmitting a game-related notification to the real-life communication client of the user, wherein the real-life communication client being separate and distinct from the game client.

In one or more embodiments, the real-life communication frontend is a voice-over-IP frontend and wherein the real-life communication client is a phone of the user.

In one or more embodiments, the real-life communication frontend is an SMS frontend and wherein the real-life communication client is a phone of the user.

In one or more embodiments, the real-life communication frontend is an email frontend.

In one or more embodiments, the real-life communication frontend is an instant messaging frontend and wherein the real-life communication client is an instant messaging client of the user.

In one or more embodiments, the game-related notification comprises a pre-recorded video message.

In one or more embodiments, the game-related notification comprises a pre-recorded audio message.

In one or more embodiments, the game server further comprises an in-game communication frontend, wherein the game client comprises an in-game communication client portion and wherein the in-game communication frontend of the game server is configured to communicate with the in-game communication client portion of the game client using a game communication protocol.

In one or more embodiments, the game server is further configured to receive a response to the game-related notification from the user, to process the received response and to take a game-related action based on the received response.

In one or more embodiments, the game-related notification comprises an instruction for the user regarding providing the response to the game-related notification.

In accordance with yet another aspect of the embodiments described herein, there is provided a non-transitory computer-readable medium embodying a set of computer-readable instructions, which, when executed in connection with a computerized system incorporating: a game server comprising a real-life communication frontend, a game client being directly accessed by the user participating in the game and a real-life communication client being directly accessed by the user, cause the computerized system to perform a computer-implemented method for enabling a game-related communication with a user participating in a game, the method involving: establishing a communication between the game server and the game client; using the game server and the game client to enable the game involving the user; and establishing a game-related communication between the real-life communication frontend of the game server and the real-life communication client of the user; and transmitting a game-related notification to the real-life communication client of the user, wherein the real-life communication client being separate and distinct from the game client.

In one or more embodiments, the real-life communication frontend is a voice-over-IP frontend and wherein the real-life communication client is a phone of the user.

In one or more embodiments, the real-life communication frontend is an SMS frontend and wherein the real-life communication client is a phone of the user.

In one or more embodiments, the real-life communication frontend is an email frontend.

In one or more embodiments, the real-life communication frontend is an instant messaging frontend and wherein the real-life communication client is an instant messaging client of the user.

In one or more embodiments, the game-related notification comprises a pre-recorded video message.

In one or more embodiments, the game-related notification comprises a pre-recorded audio message.

In one or more embodiments, the game server further comprises an in-game communication frontend, wherein the game client comprises an in-game communication client portion and wherein the in-game communication frontend of the game server is configured to communicate with the in-game communication client portion of the game client using a game communication protocol.

In one or more embodiments, the game server is further configured to receive a response to the game-related notification from the user, to process the received response and to take a game-related action based on the received response.

In one or more embodiments, the game-related notification comprises an instruction for the user regarding providing the response to the game-related notification.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary embodiment of a computerized system for integrating real-world and in-game communications of the game players.

FIG. 2 illustrates an exemplary embodiment of an operating sequence of a computerized system for integrating real-world and in-game communications of a user.

FIG. 3 shows an exemplary embodiment of a user interface of a mobile computing device of the game player illustrating integration of in-game communications and real-life communication means of a user.

FIG. 4 shows another exemplary embodiment of a user interface of a mobile computing device of the game player illustrating integration of in-game communications and real-life communication means of a user.

FIG. 5 is a block diagram that illustrates an exemplary embodiment of a client computer representing the client portion of the computerized system for integrating real-world and in-game communications of a user.

FIG. 6 is a block diagram that illustrates an exemplary embodiment of the computerized gaming server system representing the gaming server portion(s) of the distributed computerized system for integrating in-game communications and real-life communications of the user.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

In accordance with one or more embodiments described herein, in order to facilitate user's continued engagement in the game, there are provided systems and methods for establishing communication between physical communication devices of real-life users and virtual communication devices of game characters. As would be appreciated by persons of ordinary skill in the art, users in the real world usually have access to various physical communication devices executing various communication software applications. Physical communication devices utilized by users may include, without limitation, mobile phones, such as smartphones, desktop, laptop or tablet computers, smart watches as well as augmented reality head-mounted display (HMD) systems, all of which are well known to persons of ordinary skill in the art. Any of the aforesaid physical communication devices may execute one or more communication software applications including, without limitation, email clients, instant messengers (chat clients) as well as SMS messengers, all of which are also well known to persons of ordinary skill in the art.

On the other hand, various game characters within the game may use certain virtual in-game communication tools. In the gaming world, to communicate with the user (for example, in order to give the player a new mission) one can use one or more of the following communication means: non-player characters (NPC), virtual phones, which may support both phone calls and SMS messages, virtual email clients as well as other virtual communication tools.

In accordance with one or more embodiments described herein, the aforesaid virtual in-game communication means are communicatively connected with the real-life means of communication of the user such as to enable one or two-directional message exchange between the two. In one or more embodiments, the aforesaid connection is established at the request or with permission of the user.

For example, in one embodiment, the virtual in-game phone used in the game is communicatively coupled with the real-life phone of the user such as to enable exchange of calls and/or SMS between the real-life user and the gaming character. Similarly, in another embodiment, a virtual in-game email is communicatively coupled with real-life system of the user such as to enable exchange of email messages between the real-life user and the gaming character. Yet in another embodiment, virtual in-game messenger is communicatively coupled with one or more messengers of real-life user to enable message exchanges between the two. As would be appreciated by persons of ordinary skill in the art, enabling the described communications facilitates integration of various products of a company and provides additional impetus for the growth of their popularity among users.

In one or more embodiment, by virtue of the described integration, the game player is able to receive, instead of virtual in-game phone calls, real-life phone calls to user's mobile phone. In addition, the user may be able to receive, instead of virtual in-game SMS, email, and/or instant messenger messages, the real-life SMS, email, and/or instant messenger messages.

In one exemplary implementation, the described embodiments are used in conjunction with single player games, containing a game character, which is being led pursuant to a certain storyline. One exemplary embodiment of such a game is the Grand Theft Auto (GTA) series of games well known to persons of ordinary skill in the art.

In one or more embodiments, the player first inputs his or her contact information into a graphical user interface provided by the gaming client accessed by the user. In one or more embodiments, the contact information provided by the user may include, without limitation, user's real-world telephone number, email address and/or instant messenger identifier. In addition, the user may specify to the gaming system the user's game involvement schedule (e.g. days and/or hours when the user is available for playing the game). The gaming system then uses the user-specified schedule to determine when the user is not involved in playing the game and communicates with the user via various communication channels using the provided contact information during such off-game times.

For example, the gaming system may initiate a telephone call to the user's mobile phone with a pre-recorded message, such as: “At 7:30 PM today, you are directed to collect a cargo from area 1 and deliver it to area 2. Use caution as you may be followed.” The time 7:30 PM specified in the aforesaid pre-recorded message is the time when the user will be engaged in playing the game. In various embodiments, this message may be communicated to the player using other communication means, such as by means of instant messaging, live video call or SMS.

In one or more embodiments, during the gaming session, the gaming system may use the integrated in-game and real-world communication channels to send the user various communications regarding various in-game events, such as car races, etc. Similarly, during player's in-game missions, the gaming system may send player various messages, containing, for example, updates of the mission goals.

In another example, in games such as massively multiplayer online role-playing games (MMORPG), the used may receive message regarding special in-game missions or other in-game events, which are available during limited time only. Additionally, game players may receive messages from other player, such as clan members. Finally, the players may receive telephone calls from the gaming system with the specifics of in-game missions for individual game characters.

In one or more embodiments, for SMS, email and instant messages, the system provides synchronization of the player's receipt and review of the messages with the game's virtual communications. In one or more embodiments, the gaming system automatically determines when (during the game or outside of the game) and how (using which virtual and/or real means of communication) the player should be contacted. As would be appreciated by persons of ordinary skill in the art, the aforesaid user contact mechanism strongly depends on the game and user setting. Finally, in one or more embodiments, the gaming system incorporates spam detection functionality configured to detect and properly handle spam messages sent by players as well as to automatically handle complaints from players regarding spam sent by other players. Specifically, upon detection of spam sent by a user or upon receipt of a complaint regarding the user, the user may be suspended from in-game communications for a predetermined time period.

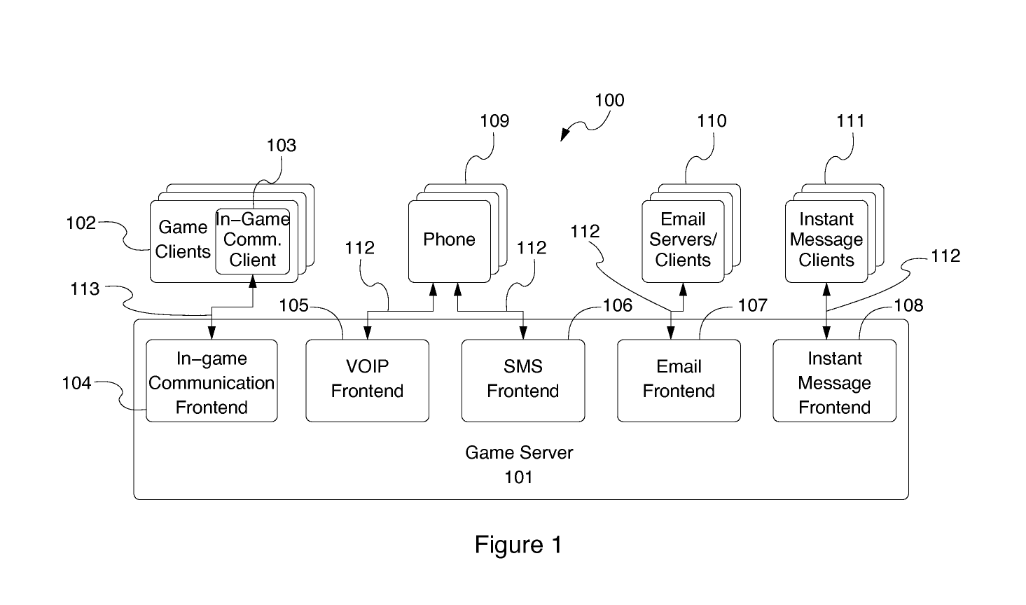

FIG. 1 illustrates an exemplary embodiment of a computerized system 100 for integrating real-world and in-game communications of the game players. The computerized system 100 incorporates a gaming server 101 connected via a network to one or more gaming clients 102. The gaming clients 102 incorporate in-game communication client portion 103, which is designed to exchange messages and data 113 with the in-game communication frontend 104 of the gaming server 101. In one or more embodiments, the gaming clients 102 and the gaming server 101 exchange information in accordance with HTTP protocol well known to persons of ordinary skill in the art. The player participating in the game uses the in-game communication client portion 103 to engage in in-game communication with other players or the gaming system in the manner described in detail above.

On the other hand, in order to implement the aforesaid inventive integration of the real-world and in-game communications of the user, the inventive gaming server 101 incorporates a VOIP frontend 105, an SMS frontend 106, an email frontend 107 and an instant message frontend 108. In one or more embodiments, the VOIP frontend 105 is configured to connect with the phone 109 of the user, such as a smartphone or a VOIP client installed on a notebook or other computing device, and enable voice communication with the player of the game. In one or more embodiments, the VOIP frontend 105 and the phone 109 of the user interact via voice-over-IP protocol well known to persons of ordinary skill in the art. As would be appreciated by ordinary artisans, the VOIP frontend 105 interacting with the phone 109 of the user enable in-game communications to be delivered directly to the phone of the player. In one or more embodiments, such in-game communications may be in a form of pre-recorded voice messages generated by the gaming server 101.

In one or more embodiments, the SMS frontend 106 is also configured to communicate with the phone 109 of the user and to enable exchange of SMS messages between the user's phone and the gaming server 101. As would be appreciated by persons of skill in the art, the SMS frontend 106 enables delivery of in-game communications to the user by means of SMS messages and receipt of SMS responses from the user to such in-game communications. In addition, the email frontend 107 is configured to communicate with email server/client 110 of the user and to deliver in-game communications to the user via email and to receive the responses from the user in email message format. Finally, the instant message frontend 108 in connection with instant message clients 111 implements a similar functionality with respect to instant message communications with the user.

In one or more embodiments, the gaming server 101 uses the VOIP frontend 105, the SMS frontend 106, the email frontend 107 and/or the instant message frontend 108 to send a game-related notification 112 to the user of a predetermined notification type and predetermined notification format. In one or more embodiments, the game-related notification 112 is sent via two or more communication channels, including, without limitation, a voice call to user's phone with a pre-recorded message, a video call, an email message, and SMS and/or an instant message. If a response to the game-related notification 112 is requires, it is sent from one of the clients 109, 110 and 111 back to the gaming server 101 via the appropriate frontend 105, 106, 107 and/or 108. In one or more embodiments, the clients 103, 109, 110 and 111 may be deployed on any suitable computing platform, such as a smartphone, a tablet computer, a notebook computer, a desktop computer, etc.

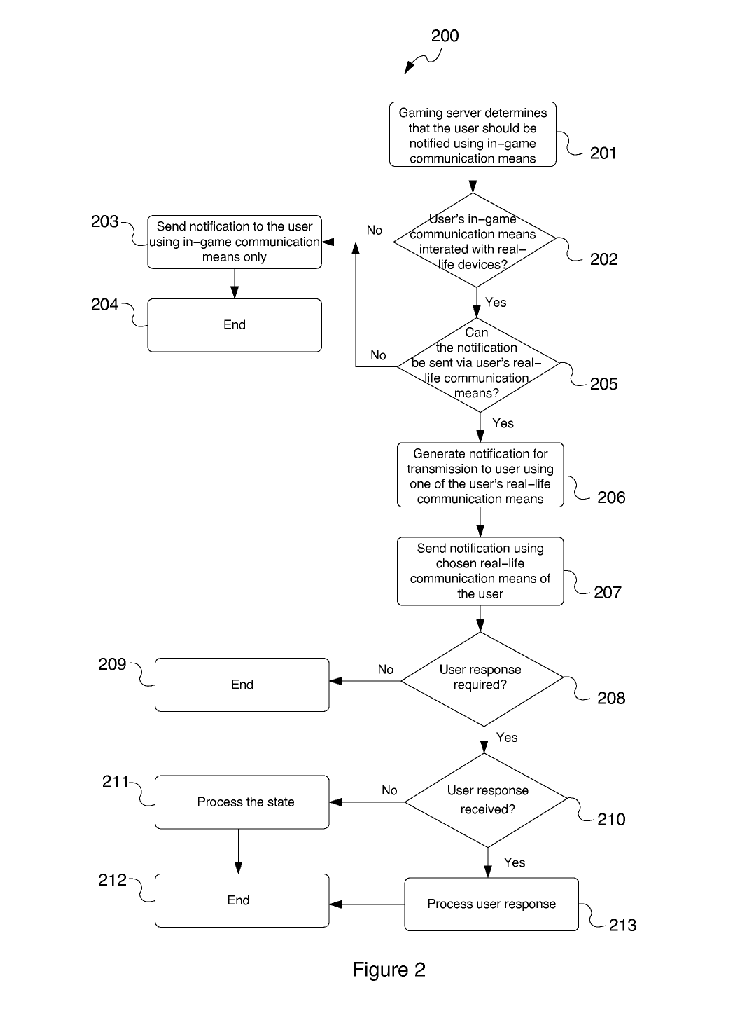

FIG. 2 illustrates an exemplary embodiment of an operating sequence 200 of a computerized system for integrating real-world and in-game communications of a user. First, at step 201, the gaming server 101 determines that the user (game player) should be sent a game-related notification using in-game communication means. At step 202, the system determines whether the in-game communication means are integrated with real-life communication devices of the user. If no re-life devices integrated with the in-game communication means are available, then, at step 203, the gaming server 101 sends the game-related notification to the user using in-game communication means only, whereupon the process terminates, see step 204.

On the other hand, if there are real-life communication devices of the user that are integrated with the in-game communication means, then, at step 205, the gaming system determined whether the communication may be sent using one of the available real-life communication devices of the user. If this option is not available, the operation proceeds to step 203, wherein the gaming server 101 sends the game-related notification to the user using in-game communication means only, whereupon the process terminates, see step 204.

Otherwise, the game-related notification is generated in step 206 for transmission to the user using one of the user's real-life communication channels. The generated notification may be in a form of a voice call to user's phone with a pre-recorded audio message or an audio generated on the fly, a video call with other game players, a live video broadcast of the game, a pre-recorded video clip, an email message, and SMS and/or an instant message. Thus, during the step 206, the gaming system 101 generates (records) the respective audio message and/or the video clip for subsequent delivery to the game player.

Subsequently, the notification generated in step 206 is sent to the user using the chosen real-life communication means, see step 207. Thereafter, at step 208, the system determines whether user's response to the sent game-related notification is required. If not, the process terminates, see step 209. Otherwise, at step 210, the system determines whether the required response to the game-related notification sent to the user has been received. If so, the received response is processed at step 213. Otherwise, the corresponding state is processed in step 211, whereupon the process terminates at step 212.

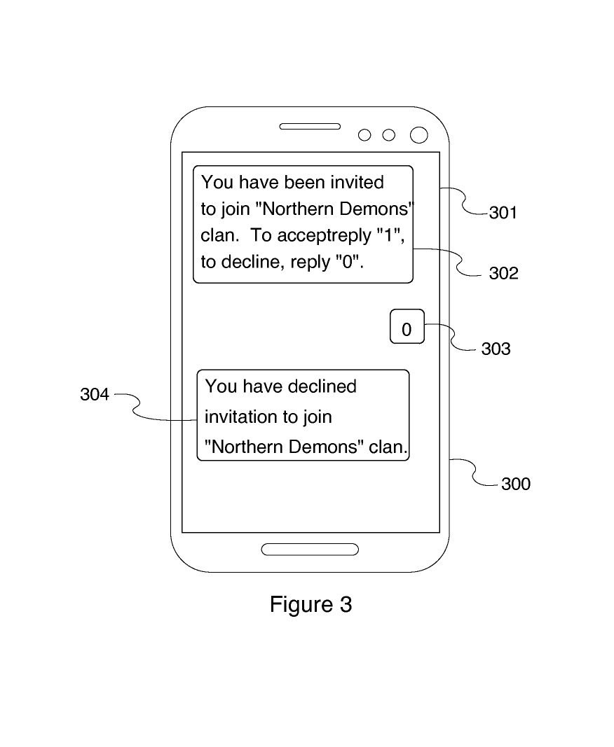

FIG. 3 shows an exemplary embodiment of a user interface of a mobile computing device of the game player illustrating integration of in-game communications and real-life communication means of a user. Specifically, FIG. 3 depicts a user interface 301 displayed on a display unit of a mobile device 300. As shown in FIG. 3, the gaming system 101 is configured to send a game-related textual notification to the user, which may incorporate, without limitation, instructions for the user on how to respond to the notification. While in the embodiment illustrated in FIG. 3 the aforesaid game-related notification is sent to the user in a format of an SMS message or instant message 302. However, in alternative embodiments, the game-related notification may be sent using other communication means, such as phone, email etc. of the user.

In one or more embodiments, the user is provided with the opportunity to respond to the game-related notification 302. In the example shown in FIG. 3, the user indicates his desire not to join the in-game clan by sending a reply message 303 containing numeral “0”. The gaming system is configured to receive the user's response, take the in-game action chosen by the user and provide a confirmatory message 303, confirming action taken by the user in connection with the game-related notification 302. In another embodiment, the gaming system may send to the user the next notification in accordance with its operating sequence.

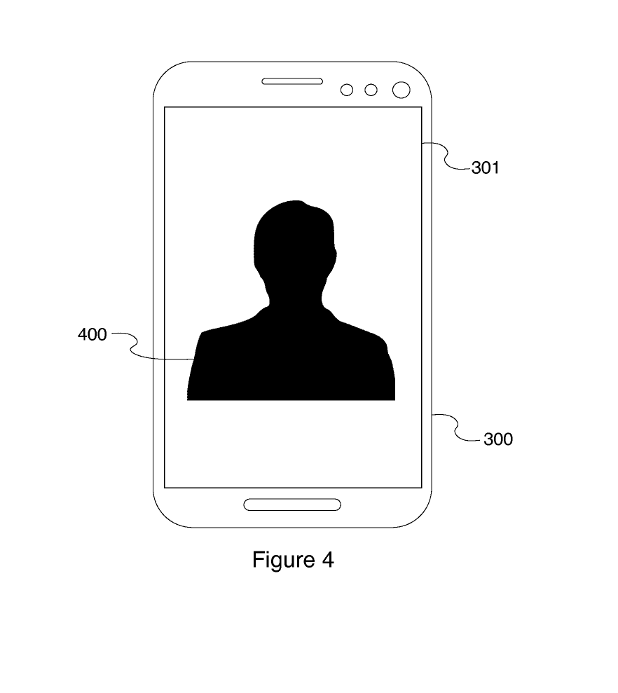

FIG. 4 shows another exemplary embodiment of a user interface of a mobile computing device of the game player illustrating integration of in-game communications and real-life communication means of a user. In the example shown in FIG. 4, the gaming server 101 communicates with the user by means of a video message, which may be delivered to the user via a messenger supporting video calls, such as Google Talk well known to persons of ordinary skill in the art, Facetime, Skype, or any other suitable communication facility. When the video call between the user's mobile computing device 300 and the gaming server 101 is established, the pre-recorded video clip 400 is played to the user. In alternative embodiments, the pre-recorded video clip 400 may be replaced with a live video related to the game, such as a live video of a simulated sporting event, or a video call with other game players.

In one or more embodiments, in addition to the video clip, the instruction is provided to the user on how to respond to the message. After the user issues the response to the gaming server 101 pursuant to the received instruction contained in the video message, the response, in a form of an audio message (e.g. a phrase) is sent back to the gaming server 101, where it is processed and the appropriate action is taken. In one or more embodiment, the conformation of the action taken in response to user's instruction may also be shown to the user.

As would be appreciated by persons or ordinary skill in the art, game-related notifications to users may be alternatively delivered using audio messages, which may be performed in the similar manner, but with pre-recorded audio messages instead of video. While the above description contained certain specific examples of game-related notification, it would be understood by persons of ordinary skill in the art that the described invention is not limited to any specific type of notification and any other game-related notification may be used in connection with the described embodiments. In addition, while phone, SMS, email and instant message communication means were specifically mentioned in the above description, the described inventive concepts are not limited to any specific communication means or protocols used by the user and any other type of communication facility may be used in connection with embodiments described herein.

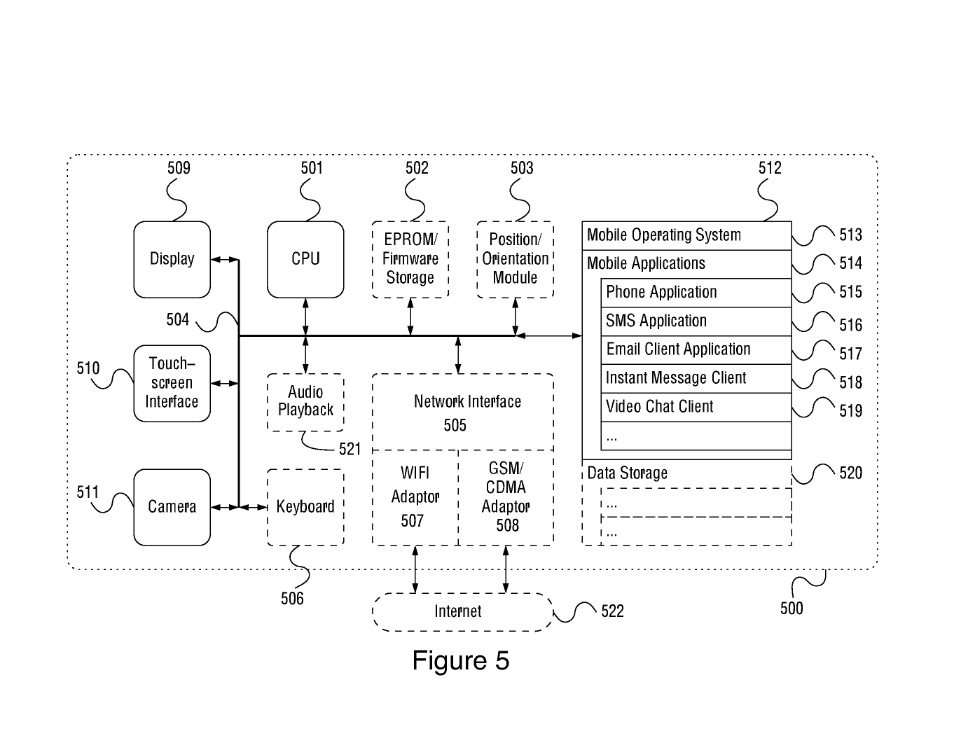

FIG. 5 is a block diagram that illustrates an exemplary embodiment of a client computer 500 representing the client portion of the computerized system for integrating real-world and in-game communications of a user. In one or more embodiments, the client computer 500 may be implemented within the form factor of a mobile computing device, such as a smartphone, a personal digital assistant (PDA), or a tablet computer, all of which are available commercially and are well known to persons of skill in the art. In an alternative embodiment, the client computer 500 may be implemented based on a desktop, a laptop or a notebook computer. Yet in an alternative embodiment, the client computer 500 may be an embedded system, incorporated into an electronic device with certain specialized functions, such as an electronic book (or e-book) reader. Yet in an alternative embodiment, the client computer 500 may be implemented as a part of an augmented reality head-mounted display (HMD) systems, also well known to persons of ordinary skill in the art.

The client computer 500 may include a data bus 504 or other interconnect or communication mechanism for communicating information across and among various hardware components of the client computer 500, and a central processing unit (CPU or simply processor) 501 coupled with the data bus 504 for processing information and performing other computational and control tasks. Client computer 500 also includes a memory 512, such as a random access memory (RAM) or other dynamic storage device, coupled to the data bus 504 for storing various information as well as instructions to be executed by the processor 501. The memory 512 may also include persistent storage devices, such as a magnetic disk, optical disk, solid-state flash memory device or other non-volatile solid-state storage devices.

In one or more embodiments, the memory 512 may also be used for storing temporary variables or other intermediate information during execution of instructions by the processor 501. Optionally, client computer 500 may further include a read only memory (ROM or EPROM) 502 or other static storage device coupled to the data bus 504 for storing static information and instructions for the processor 501, such as firmware necessary for the operation of the client computer 500, basic input-output system (BIOS), as well as various configuration parameters of the client computer 501.

In one or more embodiments, the client computer 500 may incorporate a display device 509, which may be also coupled to the data bus 504, for displaying various information to a user of the client computer 500. In an alternative embodiment, the display 509 may be associated with a graphics controller and/or graphics processor (not shown). The display device 509 may be implemented as a liquid crystal display (LCD), manufactured, for example, using a thin-film transistor (TFT) technology or an organic light emitting diode (OLED) technology, both of which are well known to persons of ordinary skill in the art. In various embodiments, the display device 509 may be incorporated into the same general enclosure with the remaining components of the client computer 500. In an alternative embodiment, the display device 509 may be positioned outside of such enclosure.

In one or more embodiments, the display device 509 may be implemented in a form of a projector or a mini-projector configured to project information on various objects, such as glasses worn by the user. In one or more embodiments, the display device 509 may be configured to be mountable on the head of the user. To this end, the display device 509 may be provided with suitable mounting hardware (not shown).

In one or more embodiments, the client computer 500 may further incorporate an audio playback device 521 connected to the data bus 504 and configured to play various audio files, such as MPEG-3 files, or audio tracks of various video files, such as MPEG-4 files, well known to persons of ordinary skill in the art. To this end, the client computer 500 may also incorporate waive or sound processor or a similar device (not shown).

In one or more embodiments, the client computer 500 may incorporate one or more input devices, such as a touchscreen interface 510 for receiving user's tactile commands, a camera 511 for acquiring still images and video of various objects, as well as a keyboard 506, which all may be coupled to the data bus 504 for communicating information, including, without limitation, images and video, as well as user command selections to the processor 501. In an alternative embodiment, input devices may include a system for tracking eye movements of the user (not shown), which may be used to indicate to the client computer 500 the command selection made by the user.

In one or more embodiments, the client computer 500 may additionally include a positioning and orientation module 503 configured to supply data on the current geographical position, spatial orientation as well as acceleration of the client computer 500 to the processor 501 via the data bus 504. The geographical position information may be obtained by the positioning module 503 using, for example, global positioning system (GPS) technology and/or other positioning techniques such as by using information provided by proximate cell towers and/or WIFI hotspots. The acceleration data is supplied by one or more accelerometers incorporated into the positioning and orientation module 503. Finally, the orientation information may be obtained using acceleration measurements in all 3 axes, including the gravity. In one or more embodiments, the position, orientation and acceleration metadata provided by the positioning and orientation module 503 is continuously recorded and stored in the data storage unit 520.

In one or more embodiments, the client computer 500 may additionally include a communication interface, such as a network interface 505 coupled to the data bus 504. The network interface 505 may be configured to establish a connection between the client computer 500 and the Internet 522 using at least one of WIFI interface 507 and the cellular network (GSM or CDMA) adaptor 508. The network interface 505 may be configured to provide a two-way data communication between the client computer 500 and the Internet 522. The WIFI interface 507 may operate in compliance with 802.11a, 802.11b, 802.11g and/or 802.11n protocols as well as Bluetooth protocol well known to persons of ordinary skill in the art. In an exemplary implementation, the WIFI interface 507 and the cellular network (GSM or CDMA) adaptor 508 send and receive electrical or electromagnetic signals that carry digital data streams representing various types of information.

In one or more embodiments, the Internet 522 typically provides data communication through one or more sub-networks to other network resources. Thus, the client computer 500 is capable of accessing a variety of network resources located anywhere on the Internet 522, such as remote media servers, web servers, other content servers as well as other network data storage resources. In one or more embodiments, the client computer 500 is configured send and receive messages, media and other data, including application program code, through a variety of network(s) including Internet 522 by means of the network interface 505. In the Internet example, when the client computer 500 acts as a network client, it may request code or data for an application program executing on the client computer 500. Similarly, it may send various data or computer code to other network resources.

In one or more embodiments, the functionality described herein is implemented by client computer 500 in response to processor 501 executing one or more sequences of one or more instructions contained in the memory 512. Such instructions may be read into the memory 512 from another computer-readable medium. Execution of the sequences of instructions contained in the memory 512 causes the processor 501 to perform the various process steps described herein. In alternative embodiments, hard-wired circuitry may be used in place of or in combination with software instructions to implement the embodiments invention. Thus, embodiments of the invention are not limited to any specific combination of hardware circuitry and software.

The term “computer-readable medium” as used herein refers to any medium that participates in providing instructions to processor 501 for execution. The computer-readable medium is just one example of a machine-readable medium, which may carry instructions for implementing any of the methods and/or techniques described herein. Such a medium may take many forms, including but not limited to, non-volatile media and volatile media.

Common forms of non-transitory computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read. Various forms of computer readable media may be involved in carrying one or more sequences of one or more instructions to processor 501 for execution. For example, the instructions may initially be carried on a magnetic disk from a remote computer. Alternatively, a remote computer can load the instructions into its dynamic memory and send the instructions over the Internet 522. Specifically, the computer instructions may be downloaded into the memory 512 of the client computer 500 from the foresaid remote computer via the Internet 522 using a variety of network data communication protocols well known in the art.

In one or more embodiments, the memory 512 of the client computer 500 may store any of the following software programs, applications or modules:

1. Operating system (OS) 513, which may be a mobile operating system for implementing basic system services and managing various hardware components of the client computer 500. Exemplary embodiments of the operating system 513 include, without limitation, Mac OS, Windows, Android, iOS, Windows and Windows Mobile and Linux, which are all well known to persons of skill in the art, as well as any other now known or later developed operating system.

2. Applications 514, which may be mobile applications, may include, for example, a set of software applications executed by the processor 501 of the client computer 500, which cause the client computer 500 to perform certain predetermined functions, such as acquire digital images using the camera 511 or play media files using the display 509 and/or an audio playback device 521. In one or more embodiments, the applications 514 may include a phone application 515, an SMS application 516, an email client application 517, an instant message client application 518 and/or video chat client application 519. The applications 515-519 are designed to work in conjunction with various frontends 105-108 of the gaming server 101 shown in FIG. 1.

3. Data storage 520 may be used, for example, for storing various data necessary for the operation of the client computer 500.

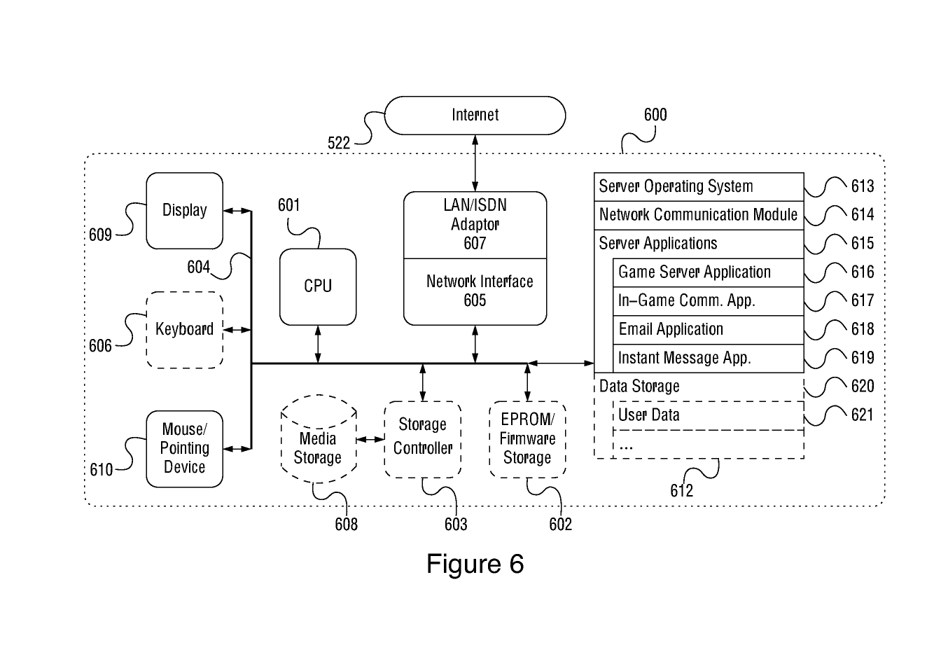

FIG. 6 is a block diagram that illustrates an exemplary embodiment of the computerized gaming server system 600 representing the gaming server portion(s) of the distributed computerized system for integrating in-game communications and real-life communications of the user. Specifically, the gaming server 101 described above may be deployed on the aforesaid computerized server system 600.

In one or more embodiments, the computerized server system 600 may incorporate a data bus 604, which may be substantially similar and may perform substantially similar functions as the data bus 504 of the client computer 500 illustrated in FIG. 5. In various embodiments, the data bus 604 may use the same or different interconnect and/or communication protocol as the data bus 504. The one or more processors (CPUs) 601, the network interface 605, the EPROM/Firmware storage 602, the display 609 and the keyboard 606 of the computerized server system 600 may be likewise substantially similar to the respective processor 501, the network interface 505, the EPROM/Firmware storage 502, the display 509 and the keyboard 506 of the client computer 500, except that the former components are deployed in a server platform configuration. In various implementations, the one or more processor 601 may have substantially increased processing power as compared with the processor 501.

In addition to the input device 606 (keyboard), the computerized server system 600 may additionally include a cursor control device 610, such as a mouse, a trackball, or cursor direction keys for communicating direction information and command selections to processor 601 and for controlling cursor movement on the display 609. This input device typically has two degrees of freedom in two axes, a first axis (e.g., x) and a second axis (e.g., y), that allows the device to specify positions in a plane.

The LAN/ISDN adaptor 607 of the computerized server system 600 may be implemented, for example, using an integrated services digital network (ISDN) card or a modem to provide a data communication connection to a corresponding type of telephone line, which is interfaced with the Internet 522 using Internet service provider's hardware (not shown). As another example, the LAN/ISDN adaptor 607 may be a local area network interface card (LAN NIC) to provide a data communication connection to a compatible LAN and the Internet 522. To store various media files, the computerized server system 600 may be provided with a media storage 608 connected to the data bus 604 by means of a storage controller 603.

In one or more embodiments, the memory 612 of the computerized server system 600 may store any of the following software programs, applications or modules:

1. Server operating system (OS) 613, which may be an operating system for implementing basic system services and managing various hardware components of the computerized server system 600. Exemplary embodiments of the server operating system 613 include, without limitation, Linux, Unix, Windows Server, FreeBSD, NetBSD, Mac OSX Server, HP-UX, AIX and Solaris, which are all well known to persons of skill in the art, as well as any other now known or later developed operating system.

2. Network communication module 614 may incorporate, for example, one or more network protocol stacks which are used to establish a networking connection between the computerized server system 600 and the various network entities of the Internet 522, such as the client computer 500, using the network interface 605 working in conjunction with the LAN/ISDN adaptor 607.

3. Server applications 615 may include, for example, a set of software applications executed by one or more processors 601 of the computerized server system 600, which cause the computerized server system 600 to perform certain predetermined functions or tasks. In one or more embodiments, the server applications 615 may include a gaming server application 616 configured to enable the game between one or more players, an in-game communication application configured to implement in-game communication of the user, as well as an email application 618 and instant message application 620 of the user, which are genera-purpose applications well known to persons of ordinary skill in the art. As described above, the game player uses the applications 617-619 to receive game-related notifications and to provide appropriate responses.

4. Data storage 620 may be used, for example, for storing user data 621.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, Objective-C, perl, shell, PHP, Java, as well as any now known or later developed programming or scripting language.

Moreover, other implementations of the invention will be apparent to those skilled in the art from consideration of the specification and practice of the invention disclosed herein. Various aspects and/or components of the described embodiments may be used singly or in any combination in the computerized systems and methods for integrating real-world and in-game communications of a user. It is intended that the specification and examples be considered as exemplary only, with a true scope and spirit of the invention being indicated by the following claims.

What is claimed is:

1. A computerized system for enabling a game-related communication with a user participating in a game, the system comprising: a game server configured to communicate with a game client, the game client being directly accessed by the user participating in the game, the game server further configured, together with the game client, to enable the game involving the user, the game server comprising a real-life communication frontend, the real-life communication frontend configured to communicate with a real-life communication client directly accessible by the user, the real-life communication client being separate and distinct from the game client, the real-life communication frontend being further configured to transmit a game-related notification to the real-life communication client of the user.

2. The computerized system of claim 1, wherein the real-life communication frontend is a voice-over-IP frontend and wherein the real-life communication client is a phone of the user.

3. The computerized system of claim 2, wherein the real-life communication frontend is an SMS frontend and wherein the real-life communication client is a phone of the user.

4. The computerized system of claim 1, wherein the real-life communication frontend is an email frontend.

5. The computerized system of claim 1, wherein the real-life communication frontend is an instant messaging frontend and wherein the real-life communication client is an instant messaging client of the user.

6. The computerized system of claim 1, wherein the game-related notification comprises a pre-recorded video message.

7. The computerized system of claim 1, wherein the game-related notification comprises a pre-recorded audio message.

8. The computerized system of claim 1, wherein the game server further comprises an in-game communication frontend, wherein the game client comprises an in-game communication client portion and wherein the in-game communication frontend of the game server is configured to communicate with the in-game communication client portion of the game client using a game communication protocol.

9. The computerized system of claim 1, wherein the game server is further configured to receive a response to the game-related notification from the user, to process the received response and to take a game-related action based on the received response.

10. The computerized system of claim 9, wherein the game-related notification comprises an instruction for the user regarding providing the response to the game-related notification.

11. A computer-implemented method for enabling a game-related communication with a user participating in a game, the computer-implemented method being performed in connection with a computerized system comprising: a game server comprising a real-life communication frontend, a game client being directly accessed by the user participating in the game and a real-life communication client being directly accessed by the user, the computer-implemented method comprising:
a. establishing a communication between the game server and the game client;
b. using the game server and the game client to enable the game involving the user; and
c. establishing a game-related communication between the real-life communication frontend of the game server and the real-life communication client of the user; and
d. transmitting a game-related notification to the real-life communication client of the user, wherein the real-life communication client being separate and distinct from the game client.

12. The computer-implemented method of claim 11, wherein the real-life communication frontend is a voice-over-IP frontend and wherein the real-life communication client is a phone of the user.

13. The computer-implemented method of claim 11, wherein the real-life communication frontend is an SMS frontend and wherein the real-life communication client is a phone of the user.

14. The computer-implemented method of claim 11, wherein the real-life communication frontend is an email frontend.

15. The computer-implemented method of claim 11, wherein the real-life communication frontend is an instant messaging frontend and wherein the real-life communication client is an instant messaging client of the user.

16. The computer-implemented method of claim 11, wherein the game-related notification comprises a pre-recorded video message.

17. The computer-implemented method of claim 11, wherein the game-related notification comprises a pre-recorded audio message.

18. The computer-implemented method of claim 11, wherein the game server further comprises an in-game communication frontend, wherein the game client comprises an in-game communication client portion and wherein the in-game communication frontend of the game server is configured to communicate with the in-game communication client portion of the game client using a game communication protocol.

19. The computer-implemented method of claim 11, wherein the game server is further configured to receive a response to the game-related notification from the user, to process the received response and to take a game-related action based on the received response.

20. The computer-implemented method of claim 19, wherein the game-related notification comprises an instruction for the user regarding providing the response to the game-related notification.

21. A non-transitory computer-readable medium embodying a set of computer-readable instructions, which, when executed in connection with a computerized system comprising: a game server comprising a real-life communication frontend, a game client being directly accessed by the user participating in the game and a real-life communication client being directly accessed by the user, cause the computerized system to perform a computer-implemented method for enabling a game-related communication with a user participating in a game, the method comprising:
a. establishing a communication between the game server and the game client;
b. using the game server and the game client to enable the game involving the user; and
c. establishing a game-related communication between the real-life communication frontend of the game server and the real-life communication client of the user; and
d. transmitting a game-related notification to the real-life communication client of the user, wherein the real-life communication client being separate and distinct from the game client.
